(19) United States
(12) Patent Application Publication
(10) Pub. No.: US 2016/0353884 A1
(43) Pub. Date: Dec. 8, 2016

(54) APPARATUS FOR STORING FOOTWEAR

(71) Applicant: Eduardo Sigal, Santa Monica, CA (US)

(72) Inventor: Eduardo Sigal, Santa Monica, CA (US)

(21) Appl. No.: 14/733,916

(22) Filed: Jun. 8, 2015

(51) Int. Cl. A47B 61/04; B60B 33/00; A47B 43/00

(52) U.S. Cl. CPC A47B 61/04; A47B 43/00; B60B 33/0002

(57) ABSTRACT

An apparatus for storing footwear including a base including a first end section and a second end section, the first end section and the second end section are on opposite sides of the base; a limb coupled to the base at the second end section, wherein the limb includes an upper portion limb with a upper portion limb width and a lower portion limb with a lower portion limb width, and wherein the upper portion limb width is greater in value than the lower portion limb width; and a hinging device coupled to the base and the limb at the lower portion limb, wherein the hinging device is configured to fold a portion of the limb.

### INTRODUCTION

This disclosure relates generally to apparatus for storing footwear. More particularly, the disclosure relates to storing footwear in a confined space.

A common problem with storage is too many items to store and not enough space to store these items. Even in sizable living areas, more often than not, storage space is at a premium. This problem is particularly more acute in confined spaces. For example, as the size of houses, condominiums and/or apartments decreases due to the increase in real estate prices, there may be a trend to maximize the living space at the expense of storage space.

### SUMMARY

Disclosed is an apparatus for storing footwear. According to one aspect, an apparatus for storing footwear including a base including a first end section and a second end section, the first end section and the second end section are on opposite sides of the base; a limb coupled to the base at the second end section, wherein the limb includes an upper portion limb with a upper portion limb width and a lower portion limb with a lower portion limb width, and wherein the upper portion limb width is greater in value than the lower portion limb width; and a hinging device coupled to the base and the limb at the lower portion limb, wherein the hinging device is configured to fold a portion of the limb.

According to another aspect, an apparatus for storing footwear including a first plurality of bases, each of the first plurality of bases including a first end section and a second end section, the first end section and the second end section are on opposite sides of each base; a first plurality of limbs, each of the first plurality of limbs coupled to a respective base from the first plurality of bases at the second end section of the respective base; and a first trunk, wherein each of the first plurality of bases is connected to a respective each of the first plurality of limbs at the first trunk.

It is understood that other aspects will become readily apparent to those skilled in the art from the following detailed description, wherein it is shown and described various aspects by way of illustration. The drawings and detailed description are to be regarded as illustrative in nature and not as restrictive.

### BRIEF DESCRIPTION OF THE DRAWINGS

FIG. 1 illustrates a side view of an example footwear storage branch in accordance with the present disclosure.

FIG. 2 illustrates the contour of a pair of footwear positioned on the footwear storage branch.

FIG. 3 illustrates a side view of an example footwear storage branch with a hinging device in accordance with the present disclosure.

FIG. 4a illustrates a side view of the example footwear storage branch of FIG. 3 in a folding position in accordance with the present disclosure.

FIG. 4b illustrates the example footwear storage branch in the folding position as shown in FIG. 4A with a placement of a footwear onto the footwear storage branch.

FIG. 5a illustrates a side view of an example footwear storage branch with a mounting plate flush against the second end plate in accordance with the present disclosure.

FIG. 5b illustrates a front view of an example mounting plate as mounted to the wall.

FIG. 6a illustrates a side view of an example footwear storage branch with a rotational device in accordance with the present disclosure.

FIG. 6b illustrates a side view of the example footwear storage branch with the rotational device in an extended position in accordance with the present disclosure.

FIG. 6c illustrates the example footwear storage branch in an extended position with the placement of a footwear.

FIG. 6d illustrates a side view of the example footwear storage branch (in a non-extended position as shown in FIG. 6a) with the contour of a pair of footwear positioned on the footwear storage branch.

FIG. 7a illustrates a front view of an example three section mounting plate.

FIG. 7b illustrates a top view of the example three section mounting plate of FIG. 7a mounted to the wall and a footwear storage branch.

FIG. 7c illustrates a top view of the example three section mounting plate of FIG. 7a mounted to the wall with a footwear storage branch and pivoted to the right in the direction of arrow.

FIG. 7d illustrates a top view of the example three section mounting plate of FIG. 7a mounted to the wall with a footwear storage branch and pivoted to the left in the direction of arrow.

FIG. 8 illustrates a back view of an example of a footwear storage tree which includes more than one footwear storage branch mounted on a trunk.

FIG. 9 illustrates a back view of an example of a multi-stack footwear storage tree.

FIG. 10a illustrates an example of a footwear storage branch with one or more telescoping section.

FIG. 10b illustrates the example of the footwear storage branch of FIG. 10a extended with the one or more telescoping section.

FIG. 10c illustrates an example of a footwear storage tree with two telescoping sections, a third telescoping section and a fourth telescoping section located on the trunk.

FIG. 10d illustrates the example of a footwear storage tree of FIG. 10c extended with the two telescoping sections on the trunk.

FIG. 11a illustrates an example of the telescoping section in a retracted form.

FIG. 11b illustrates the example of the telescoping section of FIG. 11a in an extended form.

### DETAILED DESCRIPTION

The detailed description set forth below in connection with the appended drawings is intended as a description of various aspects of the present disclosure and is not intended to represent the only aspects in which the present disclosure may be practiced. Each aspect described in this disclosure is provided merely as an example or illustration of the present disclosure, and should not necessarily be construed as preferred or advantageous over other aspects. The detailed description includes specific details for the purpose of providing a thorough understanding of the present disclosure. However, it will be apparent to those skilled in the art that the present disclosure may be practiced without these specific details. In some instances, well-known structures and devices are shown in block diagram form in order to avoid obscuring the concepts of the present disclosure. Acronyms and other descriptive terminology may be used merely for convenience and clarity and are not intended to limit the scope of the present disclosure.

While for purposes of simplicity of explanation, the methodologies are shown and described as a series of acts, it is to be understood and appreciated that the methodologies are not limited by the order of acts, as some acts may, in accordance with one or more aspects, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with one or more aspects.

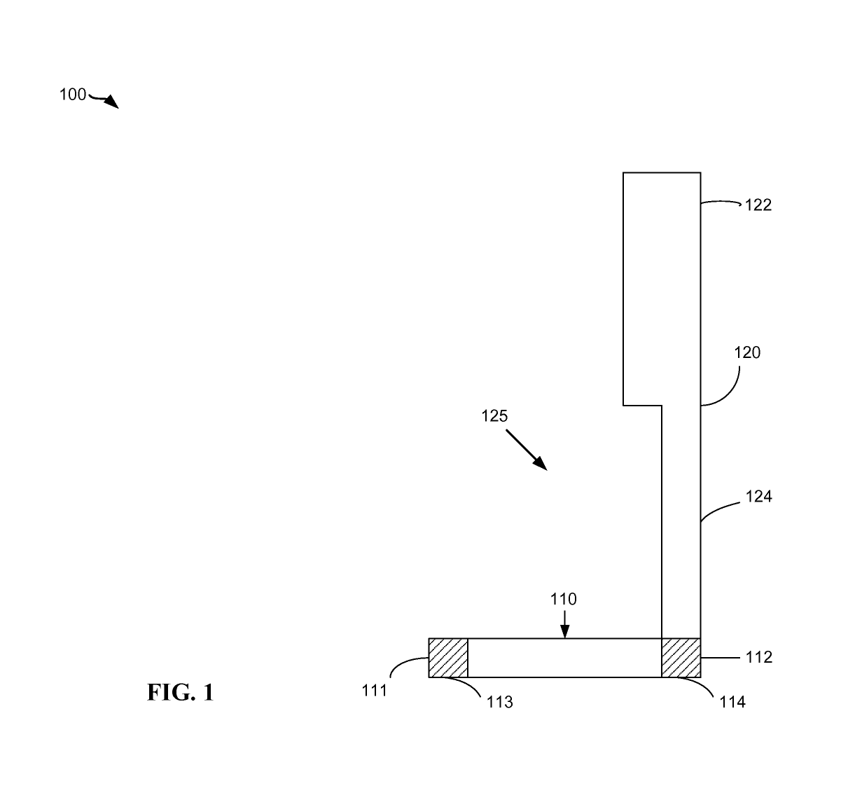

Storing a large collection of footwear, in particular boots, may consume a great deal of floor space and cause the floor to be cluttered. Additionally, the left and right components of a pair of footwear may become separated when being stored. The present disclosure is directed to a storage device for footwear. FIG. 1 illustrates a side view of an example footwear storage branch 100 in accordance with the present disclosure. The footwear storage branch 100 includes a base 110 and a limb 120. The base 110 includes a first end section 113 and a second end section 114, each on opposite sides of the base.

The base 110 includes a first end plate 111 and a second end plate 112 on the opposite side of the first end plate 111. In various examples, the first end plate 111 is a surface adjacent to the first end section 113 of the base 110, and the second end plate 112 is a surface adjacent to the second end section 114 of the base 110. The limb 120 includes an upper portion limb 122 and a lower portion limb 124. The formation of the upper portion limb 122 and the lower portion limb 124 defines a window space 125.

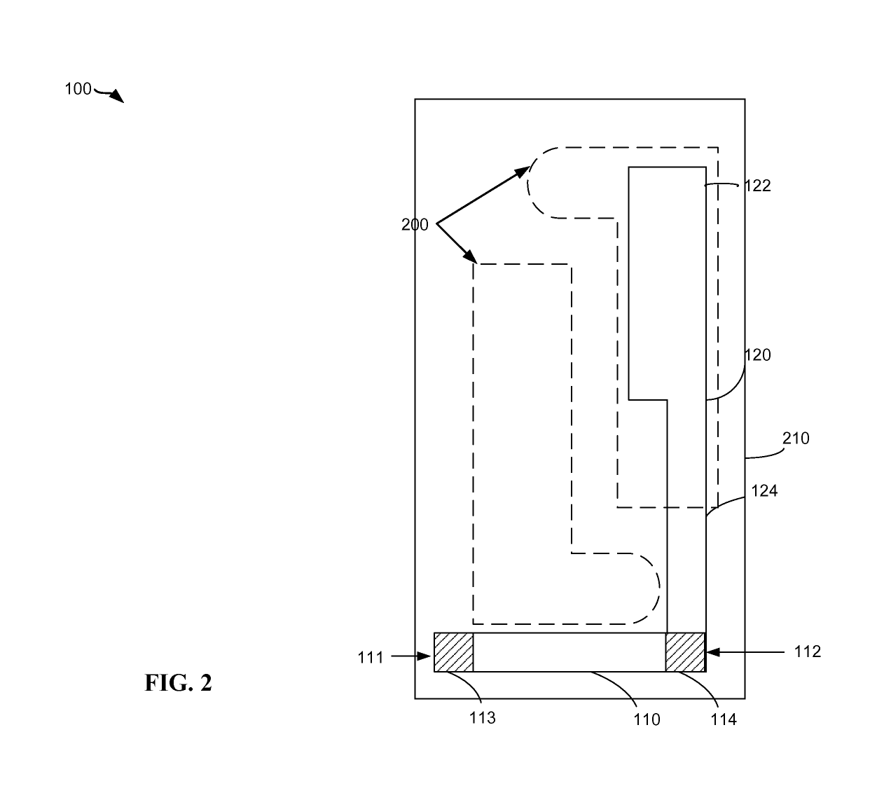

FIG. 2 illustrates the contour of a pair of footwear 200 positioned on the footwear storage branch 100. In various aspects, the storage of a footwear 200 onto the footwear storage branch 100 forms a substantially square or a substantially rectangular boundary 210. In the various aspects of allowing a pair of footwear to be positioned on the footwear storage branch 100 to form a substantially square or a substantially rectangular boundary defines a conciseness in spacing provided by the footwear storage branch 100.

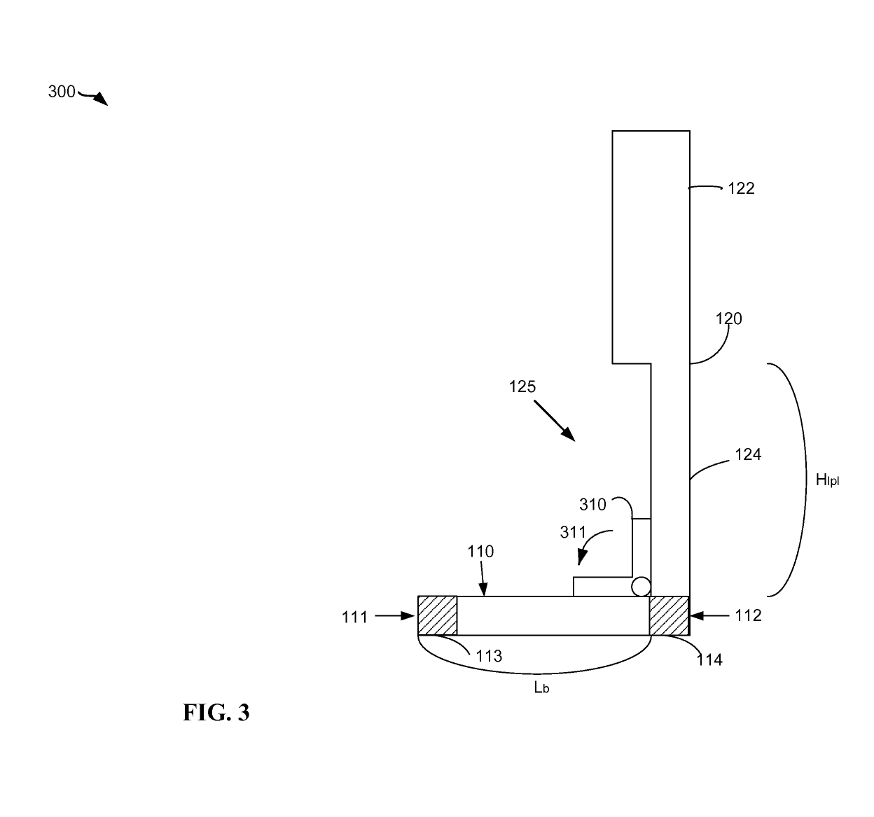

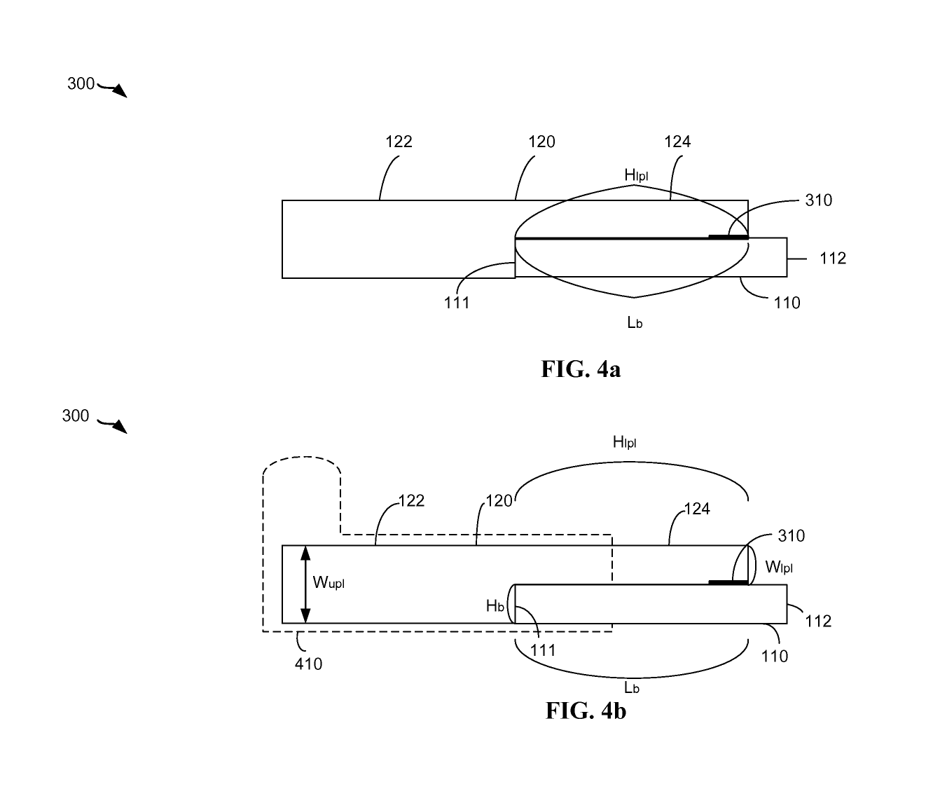

FIG. 3 illustrates a side view of an example footwear storage branch 300 with a hinging device in accordance with the present disclosure. FIG. 4a illustrates a side view of the example footwear storage branch 300 of FIG. 3 in a folding position in accordance with the present disclosure. The footwear storage branch 300 includes a hinging device 310 in the window space 125. The hinging device 310 allows the limb 120 to pivot down (in the direction of arrow 311) to meet the base 110. In various examples, the height Hₗₚₗ of the lower portion limb 124 is substantially equal to the length L_{b} of the base 110. In the various examples, with Hₗₚₗ and L_{b} being substantially equal, the lower portion limb 124 folds onto the base 110 in the folding position as shown in FIG. 4a.

FIG. 4b illustrates the example footwear storage branch in the folding position as shown in FIG. 4A with a placement of a footwear 410 onto the footwear storage branch. In various examples, the width of the upper portion limb 122 Wᵤₚₗ is of a dimension that allows the placement of the footwear 410 to slide onto the upper portion limb 122. In various examples, the width of the upper portion limb 122 Wᵤₚₗ is substantially equal to the sum of the height of the base 110 H_{b} and the width of the lower portion limb 124 Wₗₚₗ. In various examples, the width of the upper portion limb 122 Wᵤₚₗ may substantially equal the height of the base 110 H_{b}. In various examples, the width of the upper portion limb 122 Wᵤₚₗ may substantially equal the width of the lower portion limb 124 Wₗₚₗ. In various examples, the height of the base 110 H_{b}, may substantially equal the width of the lower portion limb 124 Wₗₚₗ. One skilled in the art would understand that the various dimensions mentioned herein are not exclusive. One skilled in the art would understand that various dimensions of the width and height of the upper portion limb 122, lower portion limb 124 and base 110 may be used and be within the scope and spirit of the present disclosure.

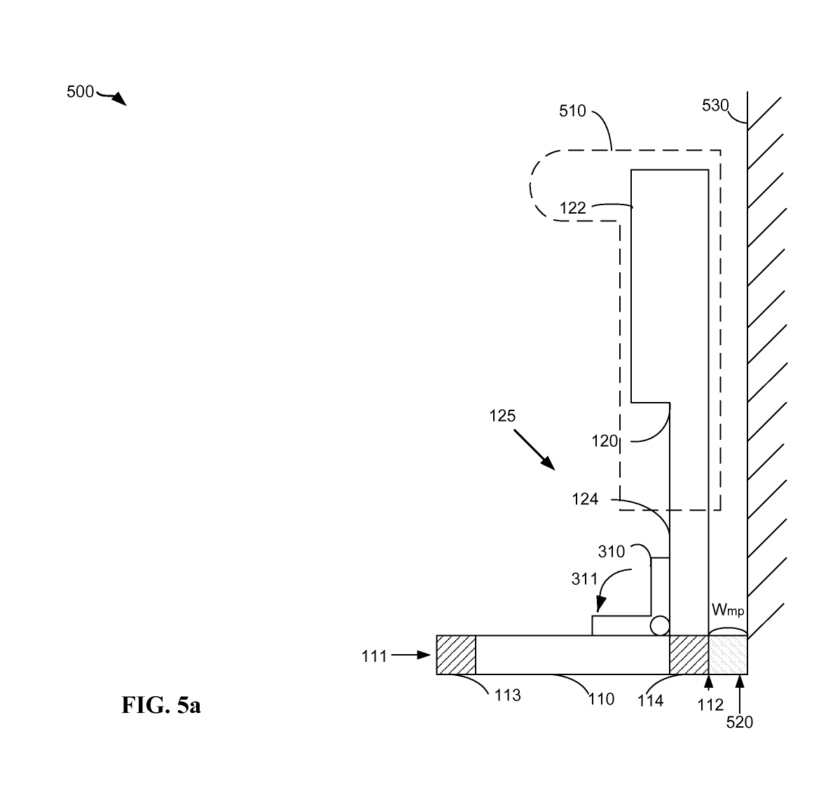

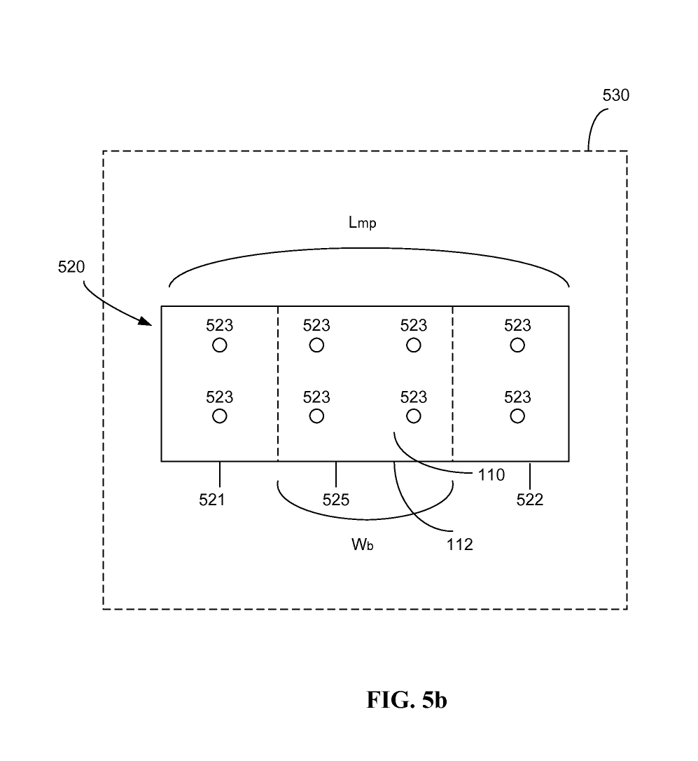

FIG. 5a illustrates a side view of an example footwear storage branch 500 with a mounting plate 520 flushed against the second end plate 112 in accordance with the present disclosure. In various examples, the mounting plate 520 couples to the wall 530 to hang the footwear storage branch 500 onto the wall 530. In various examples, the width Wₘₚ of the mounting plate 520 is large enough to wedge a footwear 510 onto the limb 120.

FIG. 5b illustrates a front view of an example mounting plate 520 as mounted to the wall 530. In various examples, the length Lₘₚ of the mounting plate 520 extends over the width W_{b} of the base 110, creating a first extension space 521 (to the stage left of the second end plate 112) and a second extension space 522 (to the stage right of the second end plate 112). It is noted that in various examples, the width W_{b} of the base 110 is the same as the width dimension of the second end plate 112. In various examples, the first extension space 521 and the second extension space 522 may each include one or more mounting hole 523. The mounting hole 523 may be used with a screw (not shown) or a nail (not shown) to mount the footwear storage branch 500 onto the wall 530. In various examples, the mounting plate 520 includes a center space 525 situated between the first extension space 521 and the second extension space 522. The center space 525 may couple to the second end plate 112, for example, through fasteners such as but not limited to adhesive tapes, screws, nails, etc. In various examples, the center space 525 may include one or more mounting hole 523 for the coupling to the second end plate 112.

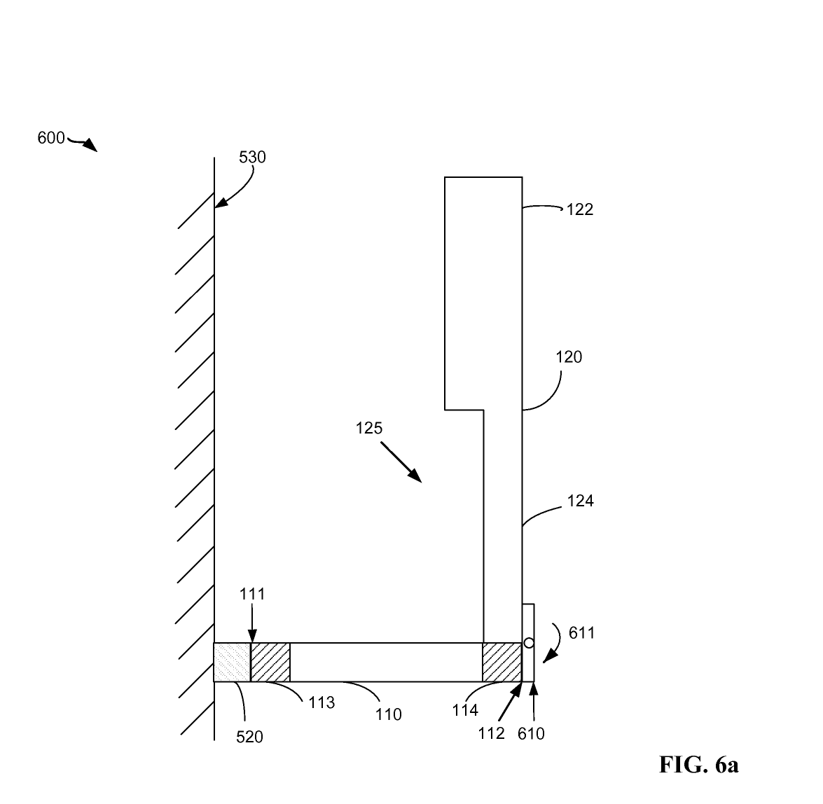

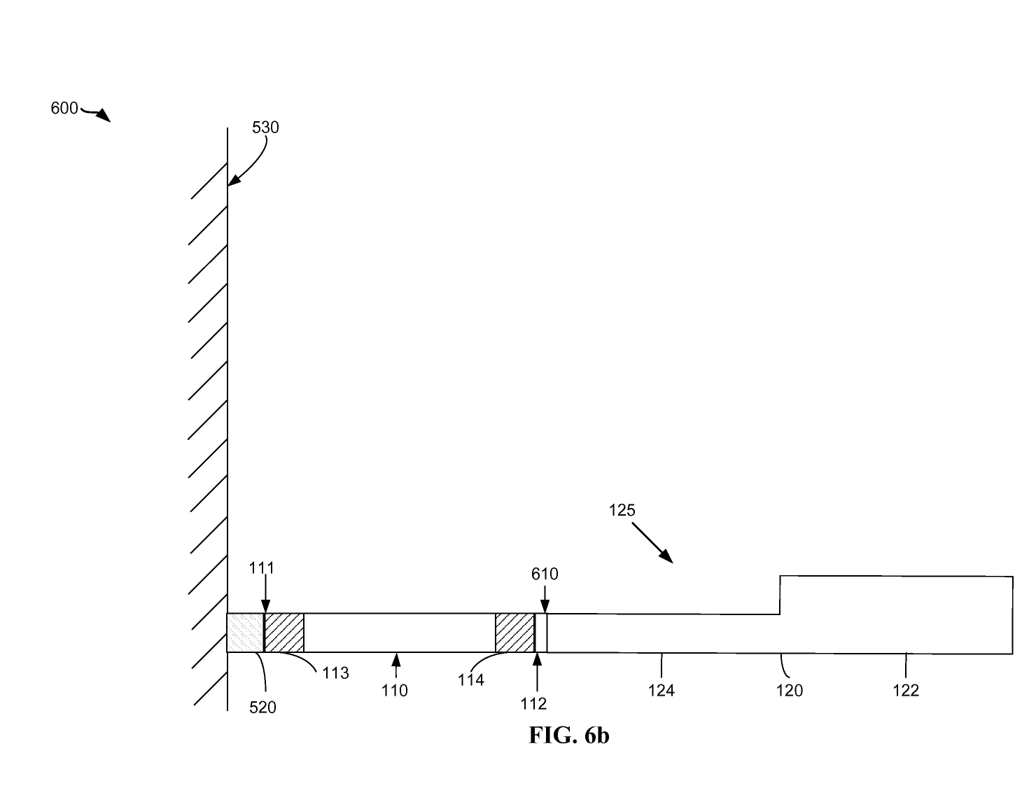

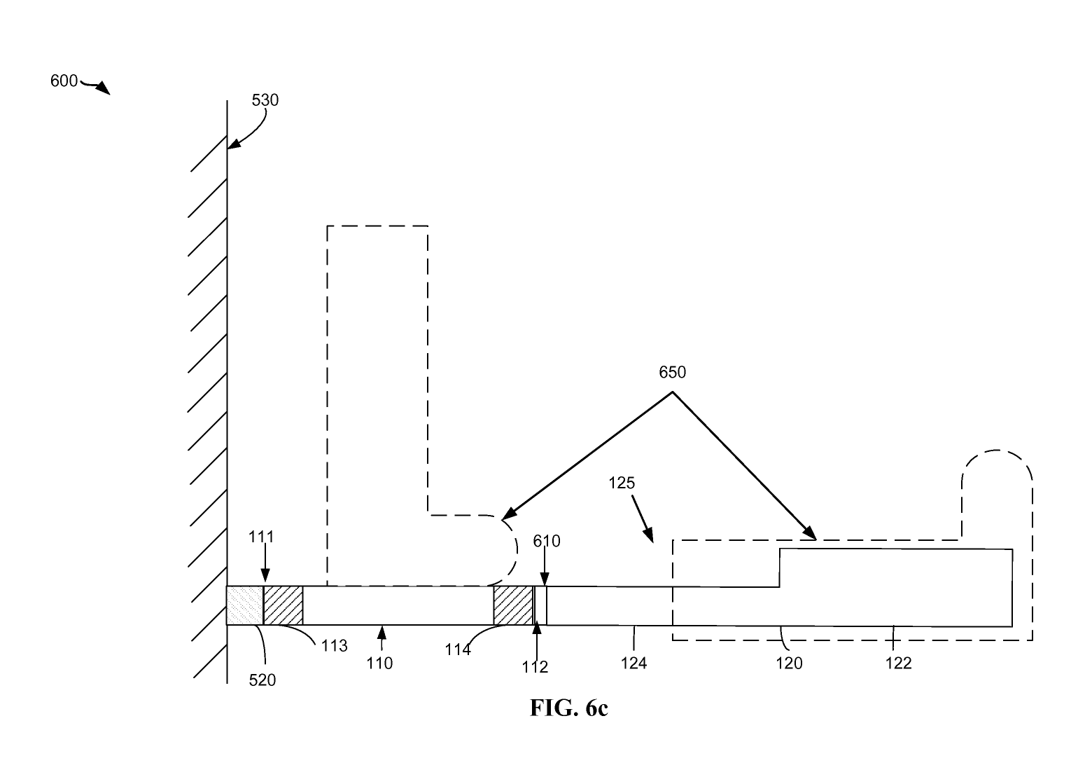

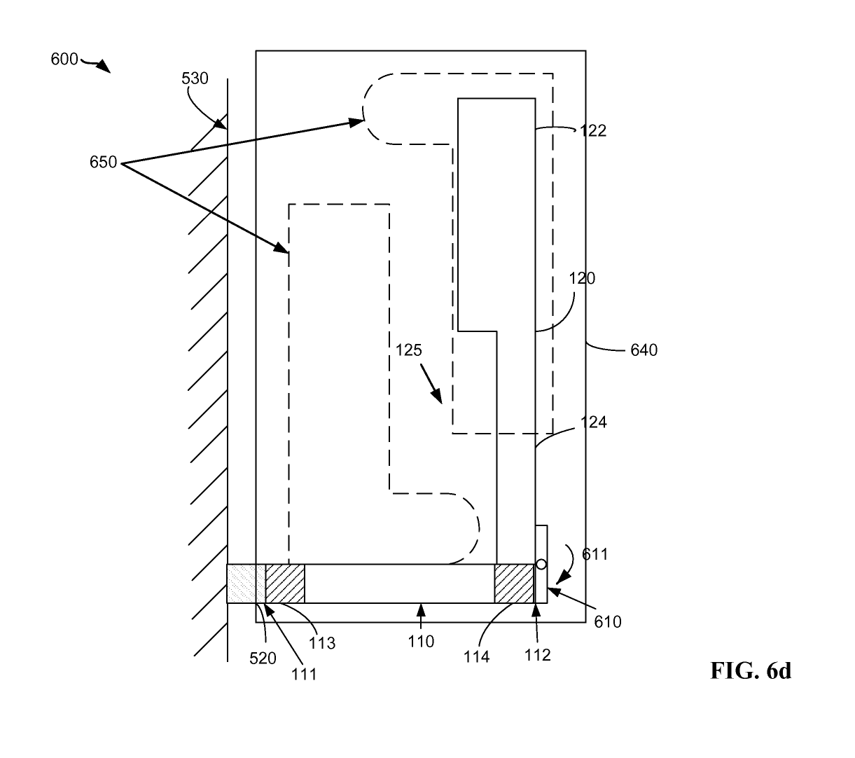

Although FIG. 5a shows a mounting plate 520 coupled onto the second end plate 112, in various other examples, the mounting plate 520 may be coupled onto the first end plate 111. FIG. 6a illustrates a side view of an example footwear storage branch 600 with a rotational device 610 in accordance with the present disclosure. In various examples, the rotational device 610 may be the same as the hinging device 310 illustrated in FIG. 3. In the various examples, where the mounting plate 520 is coupled onto the first end plate 111, a rotational device 610 is coupled between the base 110 on the second end plate 112 and the limb 120 to allow pivoting the limb 120 (in the direction of arrow 611) so as to form an extension of the base 110. FIG. 6b illustrates a side view of the example footwear storage branch 600 with the rotational device 610 in an extended position in accordance with the present disclosure. For example, in the extended position, the lower portion of the limb forms a horizontal alignment with the base as illustrated in FIG. 6b.

In various examples, when in the extended position, the footwear storage branch 600 may allow the accommodation of longer pairs of footwear. In various examples, in the extended position, the base 110 of the footwear storage branch 600 may serve as a platform for placement of a footwear as shown in FIG. 6c. FIG. 6c illustrates the example footwear storage branch 600 in an extended position with the placement of a footwear 650.

FIG. 6d illustrates a side view of the example footwear storage branch 600 (in a non-extended position as shown in FIG. 6a) with the contour of a pair of footwear 650 positioned on the footwear storage branch 600. In various aspects, the storage of a footwear 650 onto the footwear storage branch 600 forms a substantially square or a substantially rectangular boundary 640. In various examples, since the formation of the footwear storage branch 600 with its limb 120 and base 110 forms a “L” shape which further forms a “U” with the wall 530, the footwear that sits on the base 110 is secured between the limb 120 and the wall 530.

In the various aspects of allowing a pair of footwear to be positioned on the footwear storage branch 600 to form a substantially square or a substantially rectangular boundary defines a conciseness in spacing provided by the footwear storage branch 600.

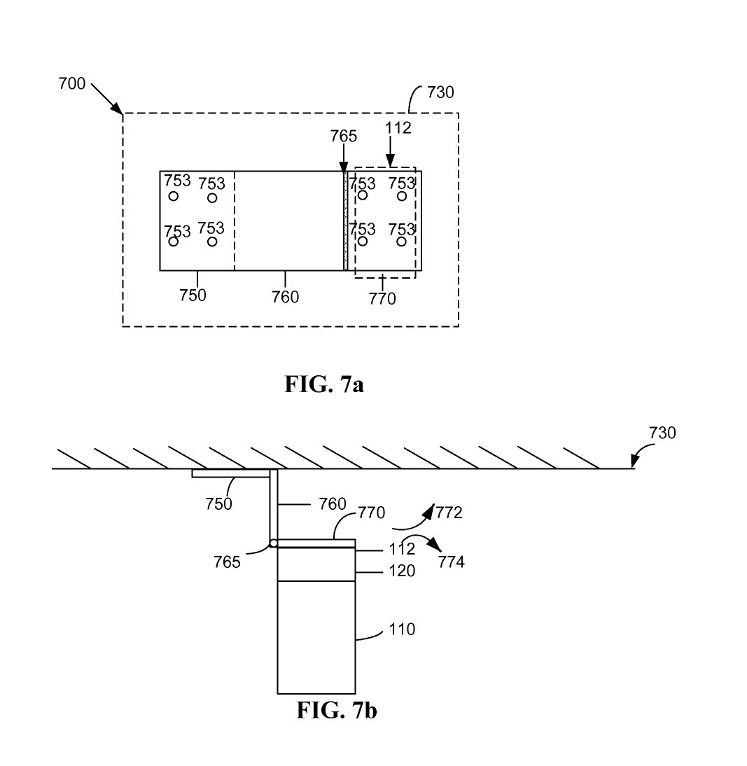

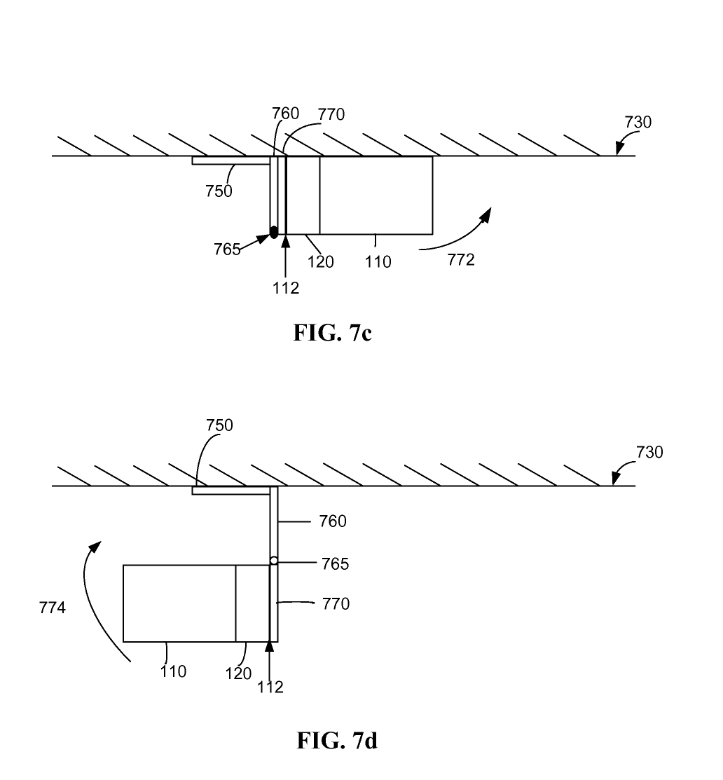

FIG. 7a illustrates a front view of an example three section mounting plate 700. In various examples, the three section mounting plate 700 includes a wall mounting section 750, a pivoting section 760 and a limb mounting section 770. The pivoting section 760 may include a rotating rod 765 adjacent to the limb mounting section 770, allowing the limb mounting section 770 to rotate to the right in the direction of arrow 772 (shown in FIG. 7b) or to the left in the direction of arrow 774 (shown in FIG. 7b). In various examples, the rotating rod 765 is configured to pivot the footwear storage branch or the base 110 at an angle range of about 180 degrees. In various examples, the rotating rod 765 may not be a rod, but may be a surface or any other component (regardless of shape) that allows a rotating motion between two adjacent surfaces.

The branch mounting section 770 may couple to the second end plate 112, for example, through fasteners such as but not limited to adhesive tapes, screws, nails, etc. In various examples, the wall mounting section 750 may include one or more mounting hole 753 for mounting the mounting plate 700 to the wall 730. In various examples, the branch mounting section 770 may include one or more mounting hole 753 for mounting a footwear storage branch. The branch mounting section 770 may also be configured to mount the base 110 of the footwear storage branch. For example, the second end plate 112 (drawn in phantom) of the footwear storage branch may be mounted to the branch mounting section 770 through one or more mounting hole 753.

FIG. 7b illustrates a top view of the example three section mounting plate 700 of FIG. 7a mounted to the wall 730 and a footwear storage branch. The footwear storage branch includes a base 120 and limb 120. In the example illustrated in FIG. 7b, the second end plate 112 of the limb 120 is mounted to the branch mounting section 770. FIG. 7c illustrates a top view of the example three section mounting plate 700 of FIG. 7a mounted to the wall 730 with a footwear storage branch and pivoted to the right in the direction of arrow 772. FIG. 7d illustrates a top view of the example three section mounting plate 700 of FIG. 7a mounted to the wall 730 with a footwear storage branch and pivoted to the left in the direction of arrow 774.

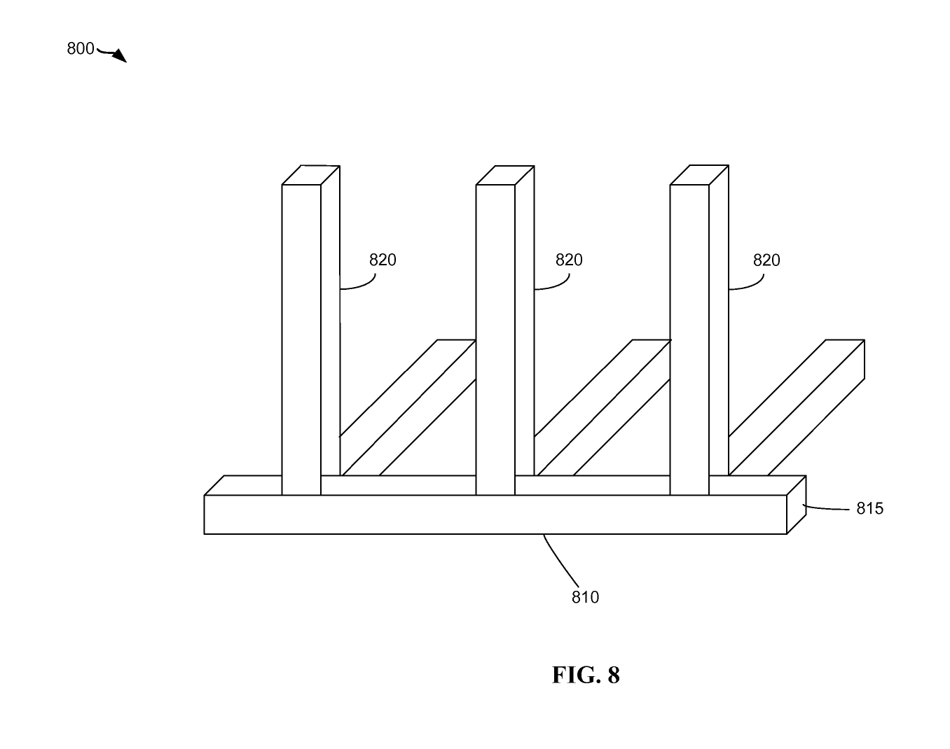

FIG. 8 illustrates a back view of an example of a footwear storage tree 800 which includes more than one footwear storage branch 820 mounted on a trunk 810. Each of the footwear storage branch 820 may be coupled to the trunk 810, for example, through fasteners such as but not limited to adhesive tapes, screws, nails, etc. In various examples, the trunk 810 may include one or more mounting hole 823 (not shown) for the coupling to each of the footwear storage branch 820. In various examples, the base 110 of each footwear storage branch 820 is connected to its respective limb 120 at the trunk 810.

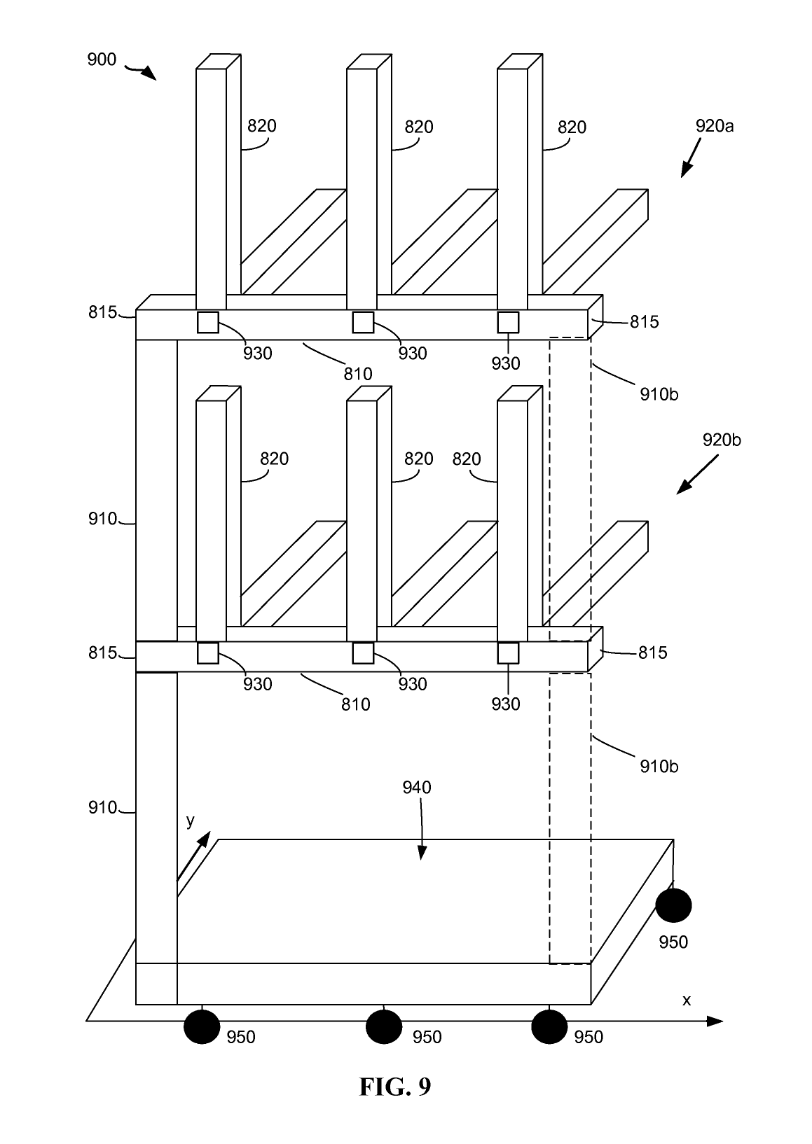

FIG. 9 illustrates a back view of an example of a multi-stack footwear storage tree 900. As shown in FIG. 9, a connecting rod 910 couples the first footwear storage tree 920a to the second footwear storage tree 920b. Although only two footwear storage trees are shown, one skilled in the art would understand that more than two footwear storage trees may be coupled together through the connecting rod 910. In various examples, the connecting rod 910 may extend beyond the lowest placed footwear storage tree (which in FIG. 9 is the second footwear storage tree 920b) to couple to a foundation plate 940. In various examples, the foundation plate 940 may span the dimension of the limbs in a first direction y and the total placement dimensions of all the footwear storage branches 820 in a second direction x. One or more wheels 950 may be attached to the foundation plate 940 for moving the multi-stack footwear storage tree 900.

Although one connecting rod 910 is illustrated in FIG. 9, additional connecting rod(s) 910 may be used within the scope and spirit of the present disclosure. For example, a second connecting rod 910b may connect the various trunks 810 with the foundation plate 940. The second connecting rod 910b is shown in phantom in FIG. 9 as it is may be regarded as an optional feature. In various examples, additional connecting rods may be added to the multi-stack footwear storage tree 900, for example, to connect one or more footwear storage tree 800 to the foundation plate 940.

In various examples, the multi-stack footwear storage tree 900 may not include a foundation plate 940. Instead, in some examples, wheels 950 may be attached to the lowest level trunk 810 for moving the multi-stack footwear storage tree 900.

In various examples, the multi-stack footwear storage tree 900 may be mounted onto a wall. For example, the mounting plate 520 illustrated in FIG. 5 may be used for the mounting. Also, for example, three section mounting plate 700 illustrated in FIG. 7 may be used for the mounting. One skilled in the art would understand that various other types of mounting mechanisms and/or mounting methods may be used for mounting the multi-stack footwear storage tree 900 and be within the scope and spirit of the present disclosure. In some examples, the mounting of the multi-stack footwear storage tree 900 is along one or more spots 930 located on one or more of the trunks 810. Although the spots 930 are shown as near and/or adjacent to the footwear storage branch 820, the locations of the spots 930 may be anywhere on the trunks 810. In other examples, the mounting of the multi-stack footwear storage tree 900 is along one or more corner spots 815 located on one or more of the trunks 810.

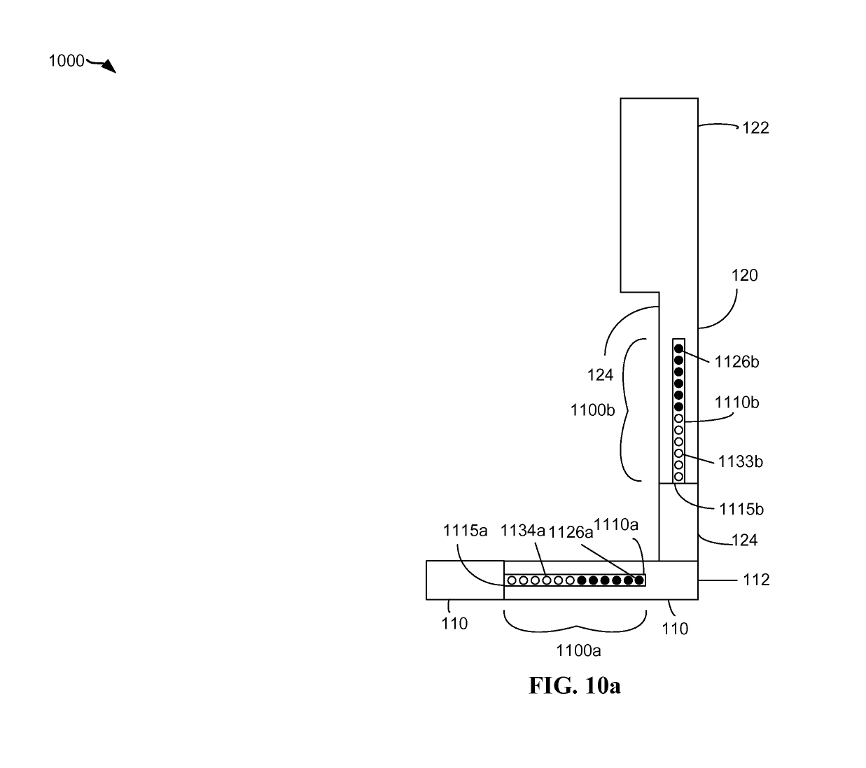

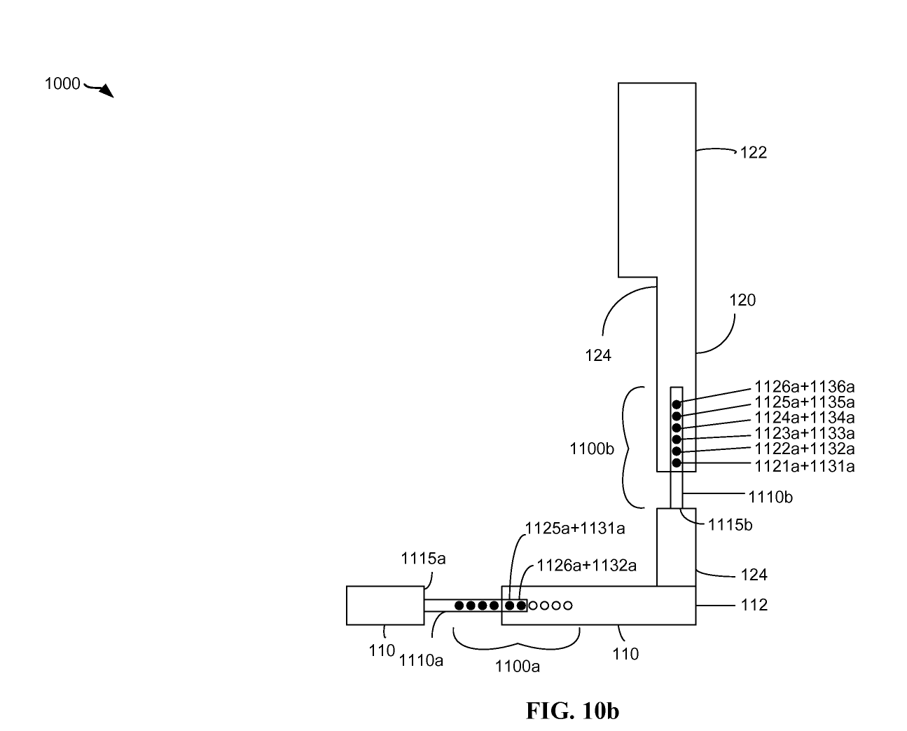

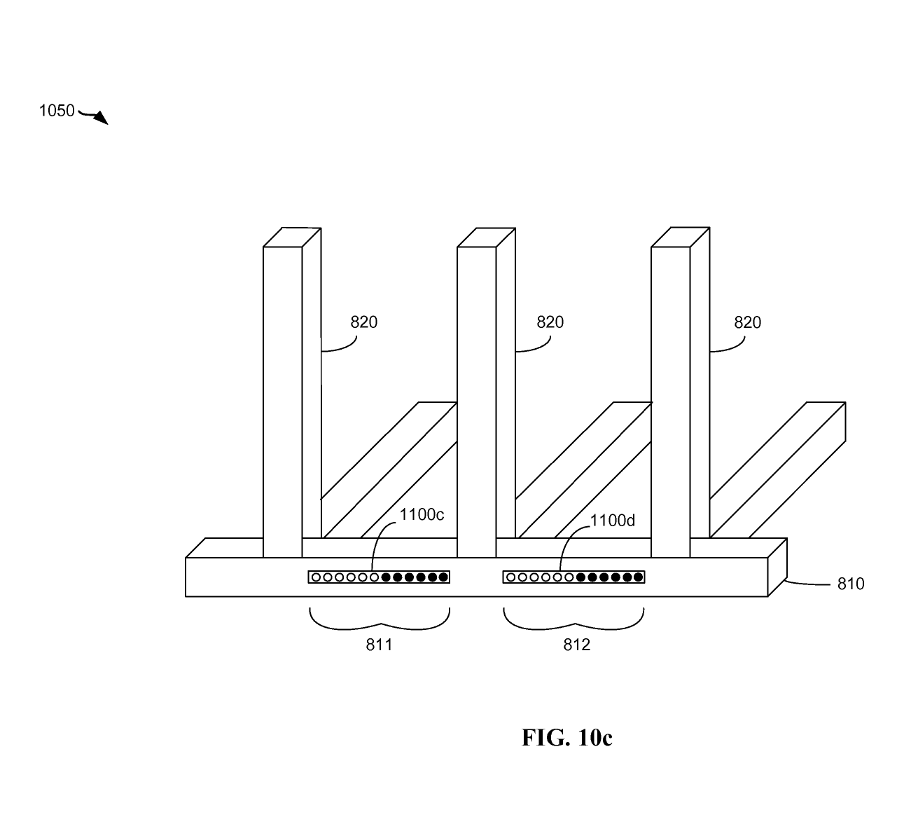

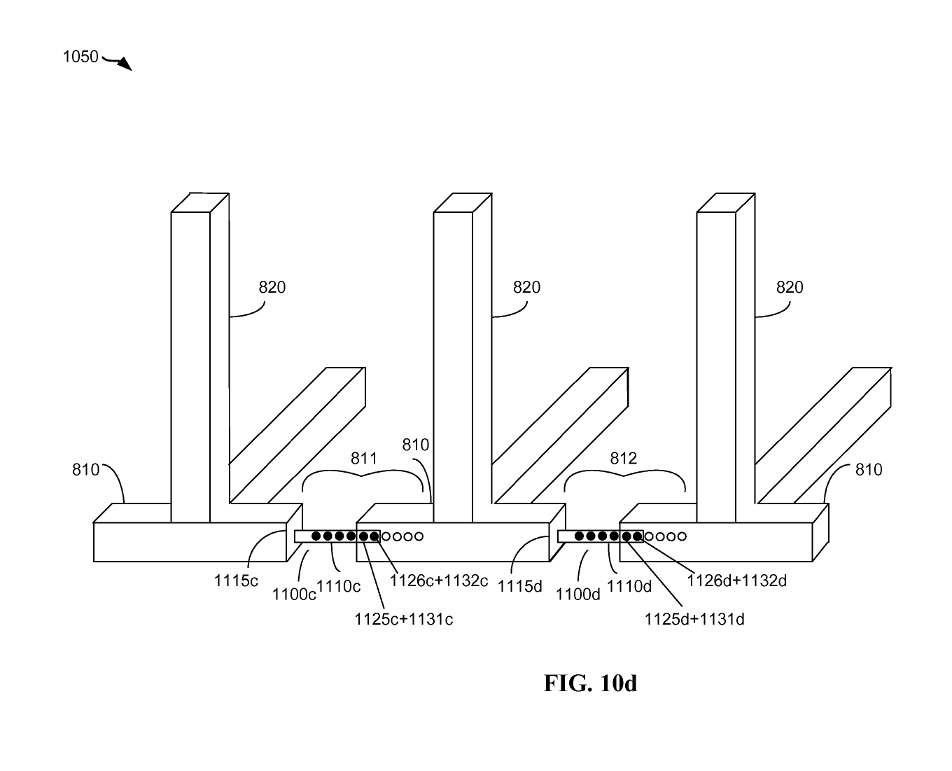

FIG. 10a illustrates an example of a footwear storage branch 1000 with one or more telescoping section 1100a, 1100b. FIG. 10b illustrates the example of the footwear storage branch 1000 of FIG. 10a extended with the one or more telescoping section 1100a, 1100b. As illustrated in FIG. 10b, the base 110 is extended with a first telescoping section 1100a and the lower portion limb 124 is extended with a second telescoping section 1100b. Shown in FIG. 10b, the base 110 is extended by locking the fifth knob 1125a with the first knob opening 1131a, and by locking the sixth knob 1126a with the second knob opening 1132a of the first telescoping section 1100a. As shown in FIG. 10b, the lower portion limb 124 is extended by locking the each of the knobs 1121b, 1122b, 1123b, 1124b, 1125b, 1126b with each of the corresponding knob openings 1131b, 1132b, 1133b, 1134b, 1135b, 1136b of the second telescoping section 1100b. In FIG. 10b, the first telescoping section 1100a includes a first edge piece 1115a as part of a first extension piece 1110a. And, the second telescoping section 1100b includes a second edge piece 1115b as part of a second extension piece 1110b.

FIG. 10c illustrates an example of a footwear storage tree 1050 with two telescoping sections, a third telescoping section 1100c and a fourth telescoping section 1100d located on the trunk 810. FIG. 10d illustrates the example of a footwear storage tree 1050 of FIG. 10c extended with the two telescoping sections 1100c, 1100d on the trunk 810. As shown in FIG. 10d, the trunk 810 is extended in two places. In the first place 811, trunk 810 is extended by locking the fifth knob 1125c with the first knob opening 1131c, and by locking the sixth knob 1126c with the second knob opening 1132c of the third telescoping section 1100c. In the second place 812, trunk 810 is extended by locking the fifth knob 1125d with the first knob opening 1131d, and by locking the sixth knob 1126d with the second knob opening 1132d of the fourth telescoping section 1100d. In various examples, the two telescoping sections 1100c, 1100d each includes a respective extension piece 1110c, 1110d with a corresponding edge piece 1115c, 1115d.

Although FIGS. 10c and 10d only show three branches 820, one skilled in the art would understand that multiple branches 820 (greater than or less than three branches 820) may be accommodated on the trunk 810 and that the scope and spirit of the present disclosure is not limited to three branches. Also, one skilled in the art would understand that although only two telescoping sections 1100c, 1100d are shown on the trunk 810 in FIGS. 10c and 10d, multiple telescoping sections (greater than or less than the two shown) may be accommodated and be within the scope and spirit of the present disclosure. In various examples, each of the branches 820 on a footwear storage tree 1050 may include one or more telescoping sections. In other examples, only some of the branches 820 on a footwear storage tree 1050 may include one or more telescoping sections. And, in other examples, some branches 820 on a footwear storage tree 1050 may include only one telescoping section while other branches 820 on the same footwear storage tree 1050 may include more than one telescoping sections. Also, while telescoping sections 1100 are illustrated only on the base 110, the lower portion limb 124 and the trunk 810, other structures may include one or more telescoping sections 1100, for example, not limited to the upper portion limb 122.

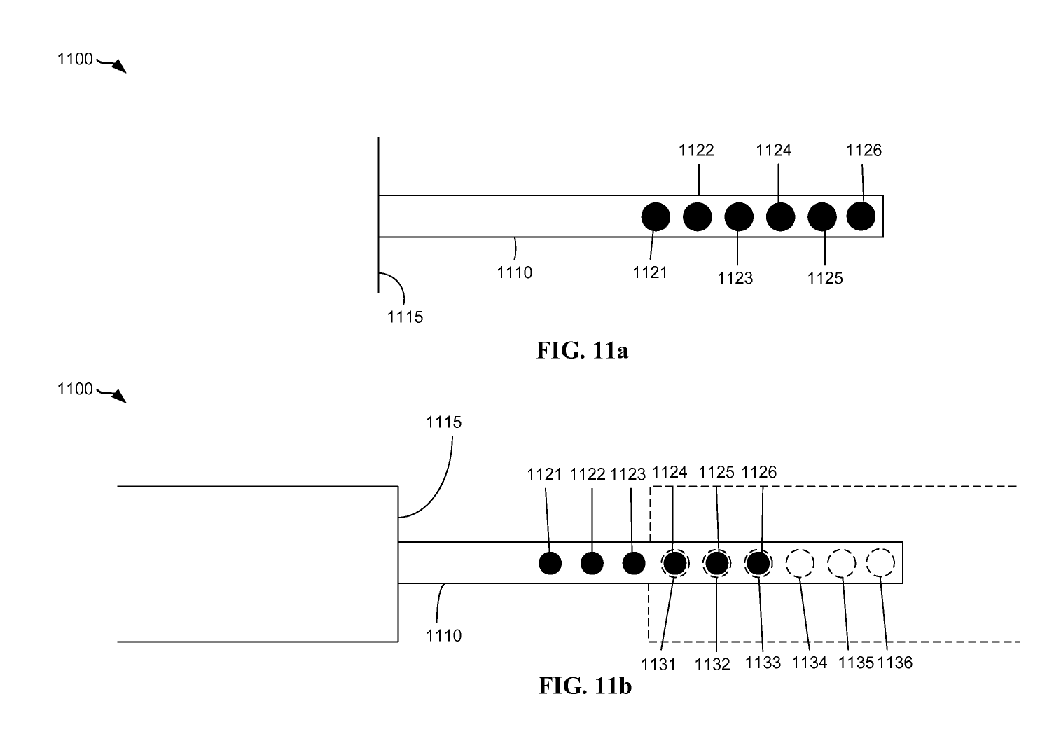

FIG. 11a illustrates an example of the telescoping section 1100 in a retracted form. FIG. 11b illustrates the example of the telescoping section 1100 of FIG. 11a in an extended form. In various examples, the telescoping section 1100 includes an extension piece 1110 and a plurality of knobs 1121-1126 that corresponds to a plurality of knob openings 1131-1136. The plurality of knobs 1121-1126 are part of the extension piece 1110 and they lock into position to the corresponding plurality of knob openings 1131-1136 that may be found on the structure that is to be extended. In the example in FIG. 11b, knob 1124 is locked to knob opening 1131, knob 1125 is locked to knob opening 1132, and knob 1126 is locked to knob opening 1133. As illustrated, the amount of extension the telescoping section 1100 provides is adjustable based on which knob is locked to which knob opening.

For example, if the telescoping section 1100 is added to the base 110 (as in FIGS. 10a, 10b) for extension, then the plurality of knob openings 1131-1136 may be found on the base 110. Similarly, if the telescoping section 1100 is added to the lower portion limb 124 (as in FIGS. 10a, 10b) for extension, then the plurality of knob openings 1131-1136 may be found on the lower portion limb 124. And, if the telescoping section 1100 is added to the trunk 810 (as in FIGS. 10c, 10d) for extension, then the plurality of knob openings 1131-1136 may be found on the trunk 810.

In some examples, the extension piece 1110 may include an edge piece 1115. The edge piece 1115 may be an edge structure of the extension piece 1110. In other examples, the edge piece 1115 may be part of any structural portion that is being extended, such as the base 110, the lower portion limb 124 and/or the trunk 810. For example, the edge piece 1115 may be coupled to the base 110 and/or the lower portion limb 124 as illustrated in FIG. 10a. Or, for example, the edge piece 1115 may be coupled to the trunk 810 as illustrated in FIG. 10c.

In various examples, the telescoping section 1100 may be applied to one or more part of the following of the footwear storage tree 1050: the base 110, the upper portion limb 122, the lower portion limb 124 and/or the trunk 810. The telescoping section 1100 allows for extensions and retractions. Depending on the quantity of the telescoping sections 1100 and their respective locations on the footwear storage tree 1050, the extensions and retractions on the footwear storage tree 1050 may be in one dimension (1D), two dimensions (2D) or in three dimensions (3D). For example, if telescoping sections 1100 are included in one of three sections (base 110, limb 120 or trunk 810), then the extension and retraction would occur in one dimension (1D). For example, if telescoping sections 1100 are included in two of three sections (base 110, limb 120 or trunk 810), then the extension and retraction would occur in two dimensions (2D). For example, if telescoping sections 1100 are included in all three sections (base 110, limb 120 or trunk 810), then the extension and retraction would occur in three dimensions (3D). Although telescoping sections 1100 may be included in all three sections of the footwear storage tree 1050 (e.g., on the base 110, on the limb 120 and on the trunk 810), one skilled in the art would understand that fewer than the three sections (the base 110, the limb 120 or the trunk 810) may include telescoping sections 1100.

The previous description of the disclosed aspects is provided to enable any person skilled in the art to make or use the present disclosure. Various modifications to these aspects will be readily apparent to those skilled in the art, and the generic principles defined herein may be applied to other aspects without departing from the spirit or scope of the disclosure.

1. An apparatus for storing footwear comprising:
a base including a first end section and a second end section, the first end section and the second end section are on opposite sides of the base;
a limb coupled to the base at the second end section, wherein the limb includes an upper portion limb with a upper portion limb width and a lower portion limb with a lower portion limb width, and wherein the upper portion limb width is greater in value than the lower portion limb width; and
a hinging device coupled to the base and the limb at the lower portion limb, wherein the hinging device is configured to fold a portion of the limb.

2. The apparatus of claim 1, wherein the hinging device is configured to fold the portion of the limb onto the base, and the portion of the limb that folds onto the base is the lower portion limb.

3. The apparatus of claim 2, wherein the base includes a height and the value of the upper portion limb width is substantially the sum of the height of the base and the lower portion limb width.

4. The apparatus of claim 3, wherein the base and the limb form a substantial rectangular shape when the portion of the limb folds onto the base.

5. The apparatus of claim 1, further comprising a mounting plate coupled to the base, and wherein the mounting plate comprises at least one extension space for coupling the mounting plate to a wall and a center space for coupling to the base.

6. The apparatus claim of 5, wherein the center space includes at least one mounting hole for coupling to the base.

7. The apparatus of claim 6, wherein the at least one extension space includes at least one mounting hole for coupling to the wall.

8. The apparatus of claim 1, further comprising a mounting plate, wherein the mounting plate comprises a wall mounting section for coupling the mounting plate to a wall, a pivoting section coupled to the wall mounting section at a first end and a branch mounting section for coupling to the center space and to the base.

9. The apparatus of claim 8, wherein the pivoting section includes a second end and a rotating rod at the second end for coupling the pivoting section to the branch mounting section, wherein the rotating rod is configured to pivot the base at an angle range of about 180 degrees.

10. The apparatus of claim 1, wherein the hinging device coupled to the base at an end plate.

11. The apparatus of claim 10, wherein the folded portion of the limb forms a horizontal alignment with the base.

12. The apparatus of claim 1, wherein the base includes a first telescoping section.

13. The apparatus of claim 12, wherein the first telescoping section includes a first plurality of knobs and a first plurality of knob openings configured to accommodate the first plurality of knobs.

14. The apparatus of claim 12, wherein the limb includes a second telescoping section.

15. The apparatus of claim 14, wherein the second telescoping section includes a second plurality of knobs and a second plurality of knob openings configured to accommodate the second plurality of knobs.

16. An apparatus for storing footwear comprising:
a first plurality of bases, each of the first plurality of bases including a first end section and a second end section, the first end section and the second end section are on opposite sides of each base;
a first plurality of limbs, each of the first plurality of limbs coupled to a respective base from the first plurality of bases at the second end section of the respective base; and
a first trunk, wherein each of the first plurality of bases is connected to a respective each of the first plurality of limbs at the first trunk.

17. The apparatus of claim 16, further comprising a first plurality of hinging devices, each of the first plurality of hinging devices coupled to one of the first plurality of bases and one of the first plurality of limbs, wherein each of the first plurality of hinging devices is configured to fold the one of the first plurality of limbs onto the one of the first plurality of bases.

18. The apparatus of claim 17, further comprising a foundation plate, the foundation plate coupled to the first trunk.

19. The apparatus of claim 18, further comprising at least one wheel attached to the foundation plate for moving the foundation plate.

20. The apparatus of claim 18, further comprising a connecting rod for coupling the foundation plate to the first trunk.

21. The apparatus of claim 16, further comprising:
a second plurality of bases, each of the second plurality of bases including an end section;
a second plurality of limbs, each of the second plurality of limbs coupled to a respective base from the second plurality of bases at the end section of the respective base; and
a second trunk, wherein each of the second plurality of bases is connected to a respective each of the second plurality of limbs at the second trunk.

22. The apparatus of claim 21, further comprising a connecting rod for coupling the second trunk to the first trunk.

23. The apparatus of claim 22, further comprising a foundation plate coupled to the second trunk.

24. The apparatus of claim 23, wherein the connecting rod is configured to couple the foundation plate to the second trunk.

25. The apparatus of claim 23, further comprising at least one wheel attached to the foundation plate for moving the foundation plate.

26. The apparatus of claim 23, wherein at least one base from the first plurality of bases or from the second plurality of bases includes a telescoping section

27. The apparatus of claim 26, wherein the telescoping section includes a plurality of knobs and a plurality of knob openings configured to accommodate the plurality of knobs.

28. The apparatus of claim 23, wherein at least one limb from the first plurality of limbs or from the second plurality of limbs includes a telescoping section.

29. The apparatus of claim 28, wherein the telescoping section includes a plurality of knobs and a plurality of knob openings configured to accommodate the plurality of knobs.

30. The apparatus of claim 23, wherein either the first trunk or the second trunk includes a telescoping section, wherein the telescoping section includes a plurality of knobs and a plurality of knob openings configured to accommodate the plurality of knobs.
